(19) United States
(12) Patent Application Publication
(10) Pub. No.: US 2024/0401381 A1
(43) Pub. Date: Dec. 5, 2024

(54) Handle Assembly and Vehicle

(71) Applicant: Illinois Tool Works Inc., Glenview, IL (US)

(72) Inventors: Bin CHEN, Shanghai (CN); Yiwei YAO, Shanghai (CN)

(21) Appl. No.: 18/675,350

(22) Filed: May 28, 2024

(30) Foreign Application Priority Data
May 31, 2023 (CN) 202310636481.4

(51) Int. Cl. E05B 85/10; E05B 81/78; E05B 85/16

(52) U.S. Cl. CPC E05B 85/107; E05B 85/103; E05B 85/16; E05B 81/78

(57) ABSTRACT

The present disclosure discloses a handle assembly and a vehicle. The handle assembly comprises a base, a handle body, a cover plate and a trigger device. The cover plate is rotatably provided on the handle body. The trigger device is provided between the handle body and the cover plate, and is configured to trigger by a relative motion between the cover plate and the handle body. The handle body and the cover plate are rotatable together relative to the base. The handle assembly of the present disclosure enables a vehicle door to be kept in a locked state when the rear of a vehicle is subjected to an unexpected impact.

### RELATED APPLICATION

The present application claims the benefit of Chinese Patent Application Nos. 202310636481.4, filed May 31, 2023, titled “Handle Assembly and Vehicle,” the contents of which are hereby incorporated by reference.

### TECHNICAL FIELD

The present disclosure relates to a handle assembly, and in particular to a handle assembly for a vehicle.

### BACKGROUND

A handle is provided on a vehicle body and is rotatable relative to the vehicle body. A trigger device is provided between the handle and the vehicle body. The rotation of the handle relative to the vehicle body can trigger the trigger device, thereby unlocking a vehicle door. However, when the rear of the vehicle is subjected to an unexpected impact, the handle may rotate relative to the vehicle body, thereby opening the vehicle door.

### SUMMARY

The present disclosure relates generally to a handle assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 is a perspective view of a handle assembly according to the present disclosure.

FIG. 2 is a perspective view of a base of the handle assembly shown in FIG. 1.

FIG. 3A is a perspective view of a handle shown in FIG. 1 and a first shaft.

FIG. 3B is an exploded view of the handle shown in FIG. 1 and the first shaft viewed from the front and above.

FIG. 3C is an exploded view of the handle shown in FIG. 1 and the first shaft viewed from the rear and above.

FIG. 4A is a schematic top view of a vehicle according to the present disclosure, with a handle in an open position.

FIG. 4B is a partial schematic diagram of the vehicle according to the present disclosure, with the handle in a closed position.

FIG. 5A is a cross-sectional view of the handle assembly when a handle body is in a closed position.

FIG. 5B is a cross-sectional view of the handle assembly when the handle body is in an unlocked position.

FIG. 5C is a cross-sectional view of the handle assembly when the handle body is in an open position.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a handle assembly. The handle assembly includes a base, a handle body, a cover plate and a trigger device. The cover plate is rotatably provided on the handle body. The trigger device is provided between the handle body and the cover plate, and is configured to trigger by a relative motion between the cover plate and the handle body. The handle body and the cover plate are rotatable together relative to the base.

According to the handle assembly described above, the handle body is rotatable about a first axis relative to the base. The cover plate is rotatable relative to the base about a second axis different from the first axis, and is rotatable together with the handle body about the first axis.

According to the handle assembly described above, the handle body and the cover plate are configured such that: the handle body and the cover plate together rotate relative to the base when an end portion of the base away from the first axis is subjected to an unexpected impact.

According to the handle assembly described above, the first axis and the second axis are provided in parallel.

According to the handle assembly described above, the trigger device is provided between the first axis and the second axis.

According to the handle assembly described above, the cover plate is rotatable relative to the handle body in between a first cover plate angle and a second cover plate angle, and the cover plate triggers the trigger device when the cover plate and the handle body form the second cover plate angle. The handle assembly further includes a cover plate reset component configured to move the cover plate relative to the handle body from the second cover plate angle towards the first cover plate angle, the first cover plate angle being smaller than the second cover plate angle.

According to the handle assembly described above, the handle body is rotatable relative to the base between a first handle angle and a second handle angle, the first handle angle being smaller than the second handle angle. The handle assembly further includes a handle body reset component configured to move the handle body from the second handle angle towards the first handle angle.

The present disclosure further provides a vehicle, including a vehicle body and the handle assembly, the base being connected to the vehicle body.

According to the vehicle described above, the vehicle further includes an external body sheet metal connected to the vehicle body. The handle body has a closed position and an open position, and is rotatable relative to the base between the closed position and the open position. The external body sheet metal and the handle assembly are configured such that: when the handle body is in the closed position, outer surface of the cover plate is flush with the external body sheet metal.

According to the vehicle described above, the handle body is rotatable about a first axis relative to the base, and the cover plate is rotatable relative to the base about a second axis different from the first axis. The first axis and the second axis are provided substantially in a vertical direction.

The handle assembly of the present disclosure enables a vehicle door to be kept in a locked state when the rear of the vehicle is subjected to an unexpected impact.

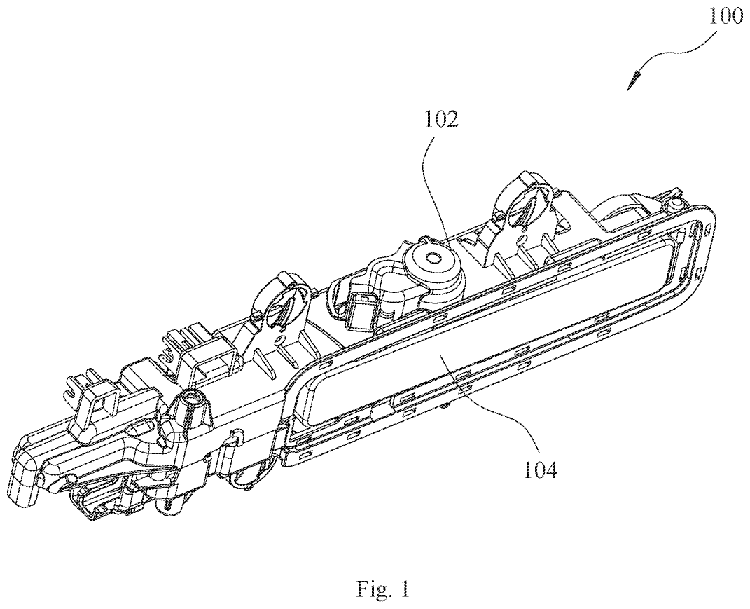

FIG. 1 is a perspective view of a handle assembly 100 according to the present disclosure. As shown in FIG. 1, the handle assembly 100 includes a base 102 and a handle 104. The handle 104 is rotatably connected to the base 102.

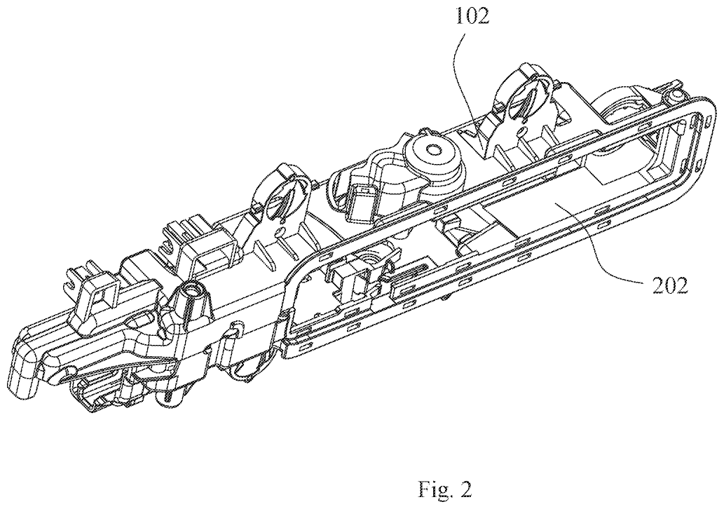

FIG. 2 is a perspective view of the base 102 of the handle assembly 100 shown in FIG. 1. As shown in FIG. 2, the base 102 is provided with a base cavity 202 for accommodating the handle 104. Specifically, the base cavity 202 is provided on a front surface of the base 102 and is formed by extending inward from the front surface of the base 102.

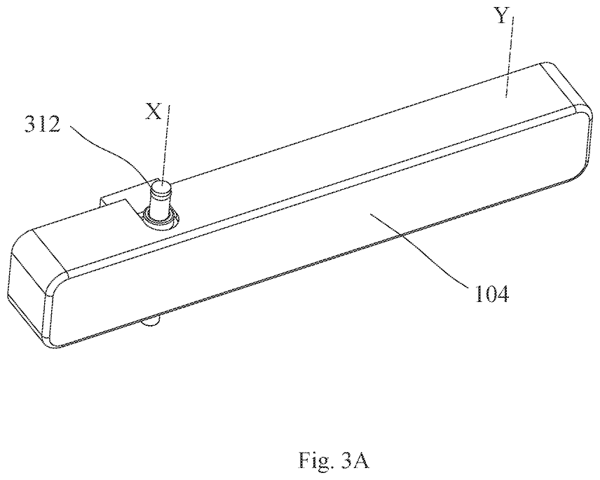

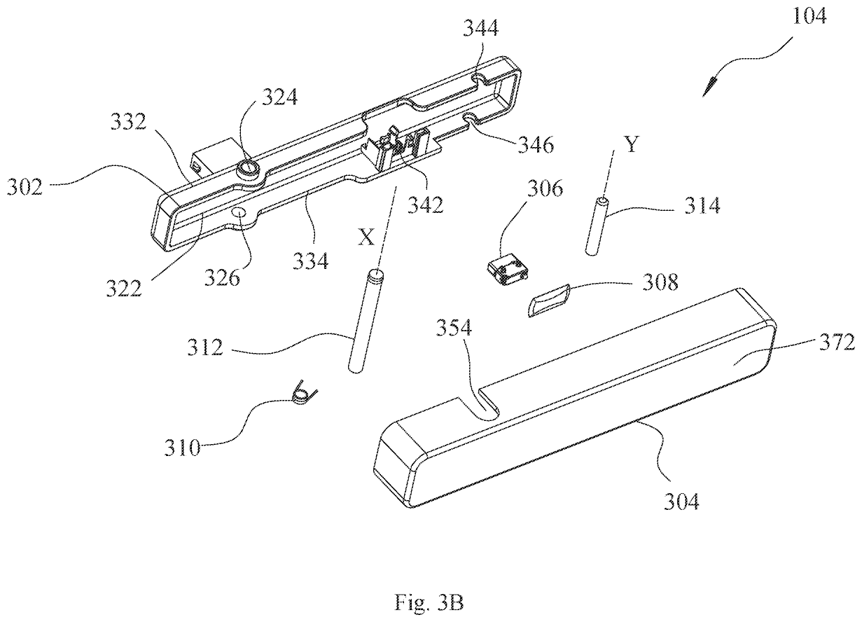

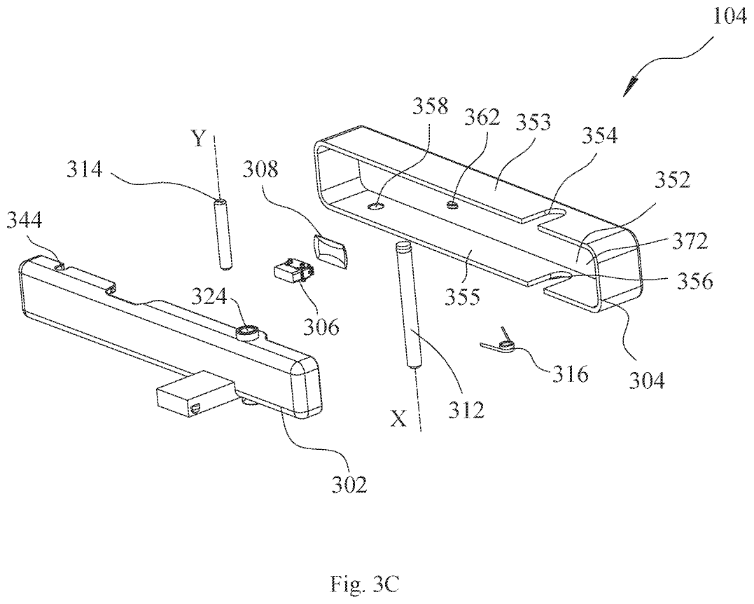

FIG. 3A is a perspective view of the handle 104 shown in FIG. 1 and a first shaft 312, FIG. 3B is an exploded view of the handle 104 shown in FIG. 1 and the first shaft 312 viewed from the front and above, and FIG. 3C is an exploded view of the handle 104 shown in FIG. 1 and the first shaft 312 viewed from the rear and above. As shown in FIGS. 3A to 3C, the handle assembly 100 includes a handle 104 and a first shaft 312. The handle 104 is rotatably connected to the base 102 via the first shaft 312.

As shown in FIGS. 3B to 3C, the handle 104 includes a handle body 302, a cover plate 304, a trigger device 306 and a second shaft 314. The handle body 302 is rotatably provided on the base 102 via the first shaft 312. The cover plate 304 is rotatably provided on the handle body 302 via the second shaft 314. The trigger device 306 is provided between the handle body 302 and the cover plate 304, and between the first shaft 312 and the second shaft 314.

As shown in FIG. 3B, the handle body 302 defines a handle body cavity 322. The handle body cavity 322 is formed by recessing inward from a front surface of the handle body 302. The left portion of the handle body 302 is provided with a first shaft upper mounting hole 324 and a first shaft lower mounting hole 326, which are used to mount the first shaft 312. Specifically, the first shaft upper mounting hole 324 is provided in an upper sidewall 332 of the handle body cavity 322 and penetrates the upper sidewall 332 in up and down directions. The first shaft lower mounting hole 326 is provided in a lower sidewall 334 of the handle body cavity 322 and penetrates the lower sidewall 334 in the up and down directions. The first shaft 312 is accommodated in the first shaft upper mounting hole 324 and the first shaft lower mounting hole 326, and the upper end and lower end of the first shaft 312 extend out of the handle body 302, respectively. The base 102 (referring to FIG. 2) is provided with a first base upper mounting hole and a second base upper mounting hole (not shown), which are used to mount the first shaft 312. The first base upper mounting hole and the second base upper mounting hole are formed by recessing inward from an upper sidewall and a lower sidewall of the base cavity 202, respectively, so as to accommodate the upper end and lower end of the first shaft 312, respectively. The lower sidewall 334 of the handle body cavity 322 is further provided with a trigger device accommodating portion 342 for accommodating the trigger device 306 and a cover plate reset component 308. In addition, a right portion of the handle body 302 is further provided with a second shaft upper mounting hole 344 and a second shaft lower mounting hole 346, which are used to mount the second shaft 314. Specifically, the second shaft upper mounting hole 344 is provided in an upper sidewall 332 of the handle body cavity 322 and penetrates the upper sidewall 332 in the up and down directions. The second shaft lower mounting hole 346 is provided in a lower sidewall 334 of the handle body cavity 322 and penetrates the lower sidewall 334 in the up and down directions. The second shaft 314 is accommodated in the second shaft upper mounting hole 344 and the second shaft lower mounting hole 346, and the upper end and lower end of the second shaft 314 extend out of the handle body 302, respectively.

As shown in FIG. 3C, the cover plate 304 defines a cover plate cavity 352. The cover plate cavity 352 is formed by recessing inward from a rear surface of the cover plate 304. A left portion of the cover plate cavity 352 is provided with a first shaft upper opening 354 and a first shaft lower opening 356. The first shaft upper opening 354 and the first shaft lower opening 356 are formed by recessing forward from rear surfaces of an upper sidewall 353 and a lower sidewall 355 of the cover plate cavity 352, respectively. When the cover plate 304 is connected to the handle body 302, the upper end and lower end of the first shaft 312 are accommodated in the first shaft upper opening 354 and the first shaft lower opening 356, respectively. The cover plate 304 is further provided with a first cover plate upper mounting hole (not shown) and a second cover plate upper mounting hole 358. The first cover plate upper mounting hole and the second cover plate upper mounting hole 358 are formed by recessing inward from an upper sidewall 353 and a lower sidewall 355 of the cover plate cavity 352, respectively, so as to accommodate the upper end and lower end of the second shaft 314, respectively. In addition, the cover plate 304 is further provided with a protrusion 362 for making contact with the cover plate reset component 308 so as to trigger the trigger device 306. The trigger device 306 is formed by protruding backward from a front surface 372 (i.e., an outer surface 372) of the cover plate cavity 352.

As shown in FIGS. 3B to 3C, when the cover plate 304 and the handle body 302 are mounted in place, the second shaft 314 rotatably connects the handle body 302 to the cover plate 304. Specifically, the second shaft 314 defines a second axis Y. The second axis Y extends in the up and down directions. The cover plate 304 and the handle body 302 are rotatable about the second axis Y. More specifically, the cover plate 304 is rotatable relative to the handle body 302 between a first cover plate angle and a second cover plate angle. The first cover plate angle is smaller than the second cover plate angle. As an example, the first cover plate angle is 0°. The second cover plate angle is 2°. When the cover plate 304 and the handle body 302 form the first cover plate angle, the handle body 302 is completely accommodated in the cover plate cavity 352. In other words, the handle body 302 covers the cover plate cavity 352. When the cover plate 304 and the handle body 302 form the second cover plate angle, the cover plate 304 makes contact with the cover plate reset component 308, such that the cover plate reset component 308 makes contact with the trigger device 306 so as to trigger the trigger device 306.

As shown in FIGS. 3B to 3C, the handle 104 further includes the cover plate reset component 308. The cover plate reset component 308 is configured to move the cover plate 304 relative to the handle body 302 from the second cover plate angle towards the first cover plate angle. As an example, the cover plate reset component 308 is a dome-shaped spring. The trigger device 306 is a sensor. The sensor includes a sensor body and a trigger portion. When an object makes contact with the trigger portion, the sensor sends a signal. The dome-shaped spring is provided between the trigger portion and the protrusion 362. Specifically, the dome-shaped spring includes a circular-arch-shaped body and an peripheral portion. The peripheral portion is provided around the periphery of the circular-arch-shaped body. The peripheral portion abuts against the handle body 302. When the cover plate reset component 308 is mounted in place between the trigger device 306 and the protrusion 362, and the cover plate 304 and the handle body 302 form the first cover plate angle, the circular-arch-shaped body does not trigger the trigger portion of the sensor (e.g., the circular-arch-shaped body is separated from or makes no pressure contact with the trigger portion of the sensor). During the process of moving the cover plate 304 relative to the handle body 302 from the first cover plate angle to the second cover plate angle, the motion of the protrusion 362 and the trigger device 306 toward each other causes the dome-shaped spring to deform and become flatter, and the deformation generated by the dome-shaped spring accumulates a first elastic restoring force. The first elastic restoring force moves the cover plate 304 relative to the handle body 302 from the second cover plate angle towards the first cover plate angle. When the cover plate reset component 308 is mounted in place between the trigger device 306 and the protrusion 362, and the cover plate 304 and the handle body 302 form the second cover plate angle, the protrusion 362 makes contact with the dome-shaped spring, and the circular-arch-shaped body triggers the trigger portion.

As shown in FIGS. 1 and 3A, when the handle body 302 and the base 102 are mounted in place, the first shaft 312 rotatably connects the handle body 302 to the base 102. Specifically, the first shaft 312 defines a first axis X. The first axis X extends in the up and down directions. In other words, the first axis X and the second axis Y are provided in parallel.

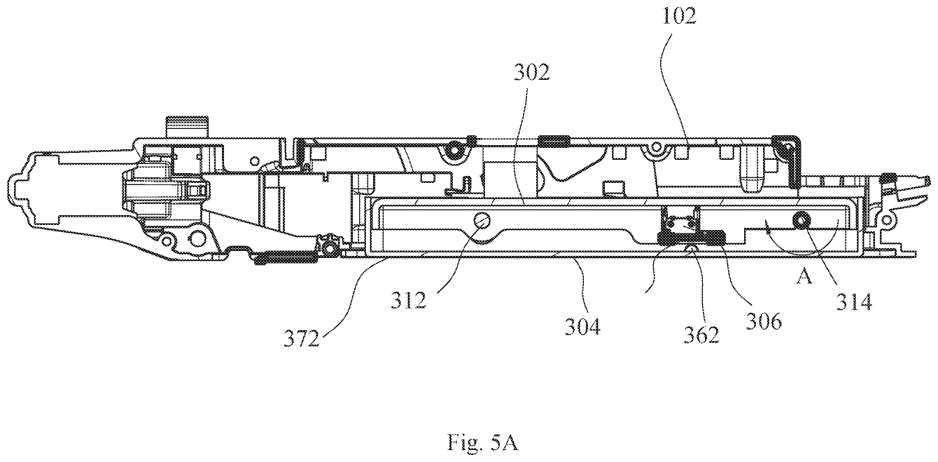

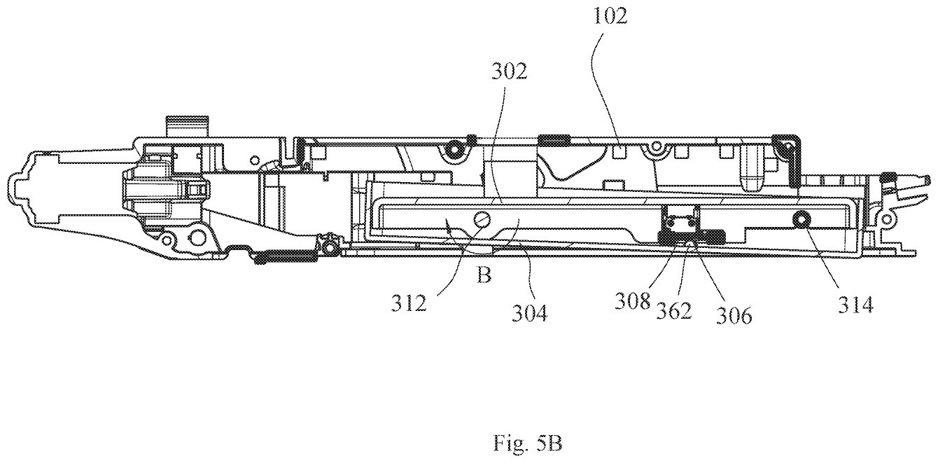

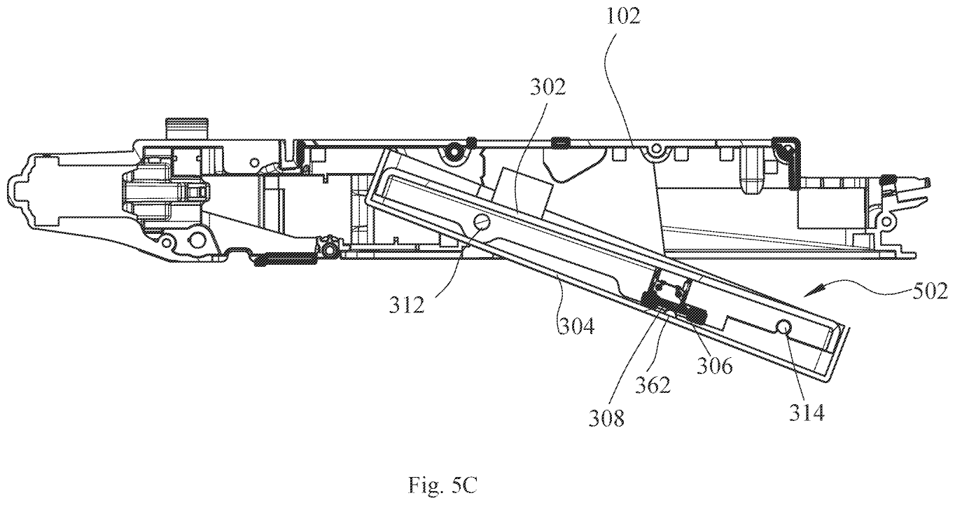

The handle body 302 is rotatable about the first axis X relative to the base 102. More specifically, the handle body 302 is rotatable relative to the base 102 between a first handle angle and a second handle angle. The first handle angle is smaller than the second handle angle. When the handle body 302 and the base 102 form the first handle angle, the handle 104 is completely accommodated in the base cavity 202. When the handle body 302 and the base 102 form the second handle angle, an accommodating space 502 is formed between the right end of the handle body 302 and the base 102 (referring to FIG. 5C). As an example, the first handle angle is 0°. The second handle angle is 20°.

It should be noted that when the handle body 302 rotates relative to the base 102 about the first axis X, the cover plate 304 rotates together with the handle body 302 relative to the base 102 about the first axis X. More specifically, the handle body 302 and the cover plate 304 are configured such that: the handle body 302 and the cover plate 304 together rotate relative to the base 102 when an end portion of the base 102 away from the first axis X is subjected to an unexpected impact.

As shown in FIGS. 3B to 3C, the handle 104 further includes a handle body reset component 310. The handle body reset component 310 is configured to move the handle body 302 relative to the base 102 from the second handle angle towards the first handle angle. As an example, the handle body reset component 310 is a torsion spring. The torsion spring is sheathed around the first shaft 312. One end of the torsion spring abuts against the base 102, and the other end of the torsion spring abuts against the handle body 302. During the process of moving the handle body 302 relative to the base 102 from the first handle angle to the second handle angle, the relative motion of the handle body 302 with respect to the base 102 causes the torsion spring to deform, and the deformation generated by the torsion spring accumulates a second elastic restoring force. The second elastic restoring force moves the handle body 302 relative to the base 102 from the second handle angle towards the first handle angle.

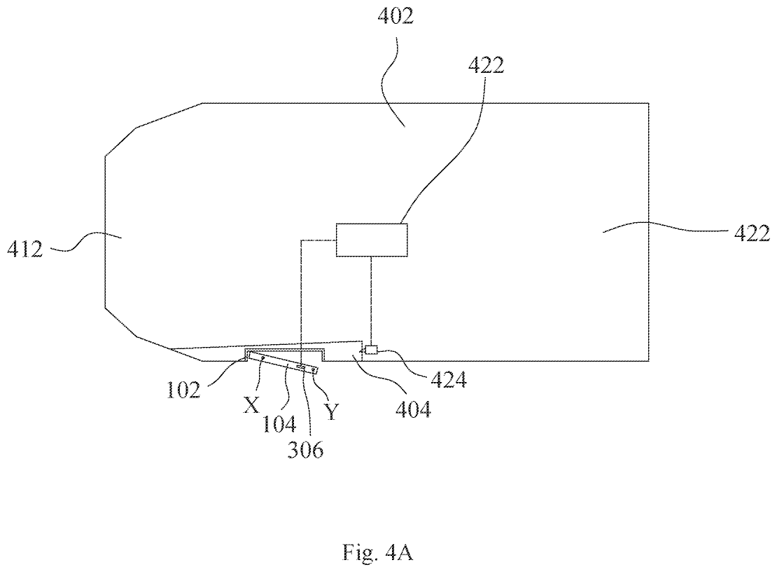

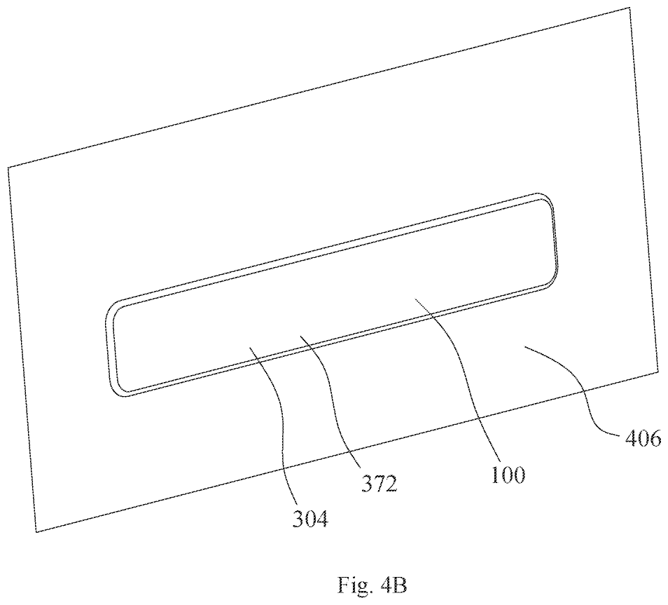

The handle assembly 100 of the present disclosure may be mounted at a position where unlocking is required. As an example, the handle assembly 100 of the present disclosure is provided on a vehicle body. The handle body 302 has a closed position and an open position, and is rotatable relative to the base 102 between the closed position and the open position. A vehicle including the handle assembly 100 of the present disclosure will be described below with reference to FIGS. 4A to 4B.

FIG. 4A is a schematic top view of a vehicle according to the present disclosure, with a handle 104 in an open position. FIG. 4B is a partial schematic diagram of the vehicle according to the present disclosure, with the handle 104 in a closed position. As shown in FIG. 4A, the vehicle includes a vehicle body 402, a vehicle door 404 and a handle assembly 100. The vehicle door 404 is rotatably provided on the vehicle body 402, and the vehicle door 404 rotates relative to the vehicle body 402 substantially around the vertical direction. The handle assembly 100 is provided on the vehicle door 404. More specifically, the base 102 of the handle assembly 100 is provided on the vehicle door 404. The handle body 302 is rotatable about the first axis X relative to the base 102. The first axis X is provided in the vertical direction. The vehicle body 402 includes a front section 412 and a rear section 422. When the handle assembly 100 is provided on the vehicle door 404, the handle assembly 100 is set such that: the first axis X in the handle assembly 100 is located closer to the front section 412 than the rear section 422, and the second axis Y is located closer to the rear section 422 than the front section 412. When the handle assembly 100 is in the open position, the handle body 302 and the base 102 form the second handle angle. The accommodating space 502 (referring to FIG. 5C) formed between the right end of the handle body 302 and the base 102 can accommodate the hand of a person. The hand of the person pulls the handle 104 outward, thereby pulling the vehicle door 404 so as to open the vehicle door 404.

As shown in FIG. 4B, when the handle assembly 100 is in the closed position, the handle body 302 and the base 102 form the first handle angle. In one example, the handle assembly 100 is set to be hidden. The outer surface 372 of the cover plate 304 is a flat surface. Specifically, the vehicle further includes an external body sheet metal 406. The external body sheet metal 406 is connected to the vehicle body 402 and covers the vehicle body 402. The handle assembly 100 and the external body sheet metal 406 are configured such that: when the handle assembly 100 is in the closed position, the outer surface 372 of the cover plate 304 is flush with the external body sheet metal 406.

As shown in FIG. 4A, in the present disclosure, the vehicle further includes a control device 422 and a locking mechanism 424. The control device 422 and the locking mechanism 424 are both provided on the vehicle body 402. The control device 422 is in signal communication with the trigger device 306 and the locking mechanism 424. When the trigger device 306 is triggered, the trigger device 306 sends a trigger signal to the control device 422, and the control device 422 sends an unlock signal to the locking mechanism 424 based on the received trigger signal. The locking mechanism 424 unlocks the vehicle door 404 after receiving the unlocking signal. The handle body 302 further has an unlocked position. During the rotation of the handle body 302 between the closed position and the open position, the handle body 302 will be in an unlocked position and unlock the locking mechanism 424. The processes from locking to unlocking of the vehicle door 404 will be described below with reference to FIGS. 5A to 5C.

FIG. 5A is a cross-sectional view of the handle assembly 100 when the handle body 302 is in the closed position. As shown in FIG. 5A, when the handle body 302 is in the closed position, the cover plate 304 and the handle body 302 form the first cover plate angle, and the handle body 302 and the base 102 form the first handle angle. The trigger device 306 is not triggered by the protrusion 362. In this case, the locking mechanism 424 (referring to FIG. 4A) locks the vehicle door 404.

FIG. 5B is a cross-sectional view of the handle assembly 100 when the handle body 302 is in the unlocked position. As shown in FIG. 5B, when the handle body 302 is in the unlocked position, the cover plate 304 and the handle body 302 form the second cover plate angle, and the handle body 302 and the base 102 form the first handle angle. The protrusion 362 makes contact with the cover plate reset component 308 and triggers the trigger device 306. The locking mechanism 424 unlocks the vehicle door 404.

FIG. 5C is a cross-sectional view of the handle assembly 100 when the handle body 302 is in the open position. As shown in FIG. 5B, when the handle body 302 is in the unlocked position, the cover plate 304 and the handle body 302 form the second cover plate angle, and the handle body 302 and the base 102 form the second handle angle. An accommodating space 502 is formed between the right end of the handle body 302 and the base 102. The protrusion 362 keeps making contact with the cover plate reset component 308 and keeps triggering the trigger device 306. The locking mechanism 424 (referring to FIG. 4A) unlocks the vehicle door 404.

When the locking mechanism 424 locks the vehicle door 404 (as shown in FIG. 5A) and a user wants to open the vehicle door 404, the user can push the left end of the outer surface 372 of the cover plate 304, resulting in the cover plate 304 rotating clockwise (e.g., in a direction A) relative to the handle body 302 about the second axis Y defined by the second shaft 314. When the cover plate 304 rotates clockwise about the second axis Y to a position where the cover plate and the base 102 form the second cover plate angle, the protrusion 362 makes contact with the cover plate reset component 308 so as to trigger the trigger device 306. The locking mechanism 424 unlocks the vehicle door 404. The handle body 302 is in the unlocked position (as shown in FIG. 5B). During the process of unlocking the vehicle door 404 by the user, the handle body 302 remains stationary relative to the base 102. In other words, during the motion of the handle body 302 from the closed position to the unlocked position, the handle body 302 does not move.

The user continues to push the left end of the outer surface 372 of the cover plate 304, resulting in the cover plate 304 and the handle body 302 (i.e., the handle 104) together rotating clockwise (e.g., in a direction B) about the first axis X defined by the first shaft 312. When the handle body 302 rotates counterclockwise about the second axis Y to a position where the handle body and the base 102 form the second handle angle, an accommodating space 502 is formed between the right end of the handle body 302 (i.e., the right end of the handle 104) and the base 102 so as to allow the user to grasp the right end of the handle 104 (as shown in FIG. 5C). Thus, the user can pull the handle 104, thereby pulling the vehicle door 404 so as to open the vehicle door 404.

As an example, when the user wants to open the vehicle door 404, the user can reach out the hand and press the left end of the outer surface 372 of the cover plate 304 with the thumb. After the user sees that the right end of the handle 104 protrudes from the external body sheet metal 406, the user can extend four fingers into the accommodating space 502 formed between the right end of the handle body 302 and the base 102, and pull the handle 104 so as to open the vehicle door 404. During the process of the user pressing the left end of the outer surface 372 of the cover plate 304 with the thumb, the trigger device 306 is naturally triggered. The actions of the user for door opening are very smooth, so that the use experience is good.

It should be noted that although the present disclosure shows that the trigger device 306 is triggered by the abutment of the protrusion 362 on the cover plate 304, in other examples, the trigger device 306 is configured to be triggered by the relative motion of the cover plate 304 and the handle body 302.

In the prior art, the rotation of the handle relative to the vehicle body can trigger the trigger device, so that the locking mechanism can unlock the vehicle door. When the user expects to unlock the vehicle door, the user can unlock the vehicle door by pulling the handle. When the rear of the vehicle is subjected to an unexpected impact, the handle may rotate relative to the vehicle body, thereby unlocking the vehicle door, so that the vehicle door is unexpectedly unlocked. Specifically, when the rear of a vehicle is subjected to an unexpected impact, a handle is inclined with respect to the vehicle body due to the fact that various components in the vehicle have the inertia to maintain their original states, resulting in the vehicle door being unlocked. In order to prevent the vehicle door from being unlocked, two solutions are generally adopted in the prior art. The first solution is to provide an inertia lock or inertia block cooperating with the handle on the handle to prevent the vehicle door from being unlocked. However, the inertia lock or inertia block needs to be additionally provided. The inertia lock or inertia block occupies a large space at the rear side of the handle, resulting in a larger overall thickness of the vehicle door. The second solution is to provide a button on the cover plate of the handle assembly, and trigger the trigger device after the user presses the button, so as to unlock the locking mechanism. This arrangement is not attractive in appearance, and the user needs to press a specific position (i.e., the button position), so that the user experience is poor.

In the present disclosure, the handle body 302 and the cover plate 304 are configured such that: the handle body 302 and the cover plate 304 together rotate relative to the base 102 when an end portion of the base 102 away from the first axis X is subjected to an unexpected impact. When the vehicle stops moving and the rear of the vehicle (e.g., the rear section 422 shown in FIG. 4A) is subjected to an unexpected impact, the handle 104 remains in the original position and the vehicle body 402 is impacted to be inclined with respect to the handle 104 due to the fact that various components in the vehicle have the inertia to maintain their original states. In this case, although the vehicle body 402 is inclined with respect to the handle 104, since there is no relative motion between the handle body 302 and the cover plate 304, the trigger device 306 will not be triggered, and the vehicle door 404 is in the locked state. The vehicle of the present disclosure does not need to be provided with an additional inertia lock or inertia block. Thus, the overall thickness of the vehicle door of the present disclosure is small. In addition, in present disclosure, the trigger device 306 is triggered by the relative motion between the cover plate 304 and the handle body 302, so there is no need to provide a button on the cover plate 304, which makes the surface of the cover plate 304 attractive. In addition, since no button is provided, the user no longer needs to perform operations on a specific area, instead can press any position on the left end portion of the cover plate 304, which gives the user greater freedom and greatly enhances the user experience. In addition, the left end of the cover plate 304 is closer to the trigger device 306 than the second axis Y, so that the user can trigger the trigger device 306 by applying a small force, which can further enhance the user experience.

Although the present disclosure is described with reference to the examples of embodiments outlined above, various alternatives, modifications, variations, improvements and/or substantial equivalents, which are known or anticipated at present or to be anticipated before long, may be obvious to those of at least ordinary skill in the art. Furthermore, the technical effects and/or technical problems described in this specification are exemplary rather than limiting. Therefore, the disclosure in this specification may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to embrace all known or earlier disclosed alternatives, modifications, variations, improvements and/or substantial equivalents.

What is claimed is:

1. A handle assembly, comprising:
a base (102);
a handle body (302);
a cover plate (304) rotatably provided on the handle body (302); and
a trigger device (306) provided between the handle body (302) and the cover plate (304), and being configured to trigger by a relative motion between the cover plate (304) and the handle body (302);
wherein the handle body (302) and the cover plate (304) are rotatable together relative to the base (102).

2. The handle assembly according to claim 1, wherein:
the handle body (302) is rotatable about a first axis (X) relative to the base (102); and
the cover plate (304) is rotatable relative to the base (102) about a second axis (Y) different from the first axis (X), and is rotatable together with the handle body (302) about the first axis (X).

3. The handle assembly according to claim 2, wherein:
the handle body (302) and the cover plate (304) are configured such that: the handle body (302) and the cover plate (304) together rotate about the first axis (X) relative to the base (102) when an end portion of the base (102) away from the first axis (X) is subjected to an unexpected impact.

4. The handle assembly according to claim 2, wherein:
the first axis (X) and the second axis (Y) are provided in parallel.

5. The handle assembly according to claim 2, wherein:
the trigger device (306) is provided between the first axis (X) and the second axis (Y).

6. The handle assembly according to claim 1, wherein:
the cover plate (304) is rotatable relative to the handle body (302) between a first cover plate angle and a second cover plate angle, and the cover plate (304) triggers the trigger device (306) when the cover plate (304) and the handle body (302) form the second cover plate angle; and
the handle assembly further comprises a cover plate reset component (308) configured to move the cover plate (304) relative to the handle body (302) from the second cover plate angle to the first cover plate angle, and the first cover plate angle is smaller than the second cover plate angle.

7. The handle assembly according to claim 1, wherein:
the handle body (302) is rotatable relative to the base (102) between a first handle angle and a second handle angle, the first handle angle is smaller than the second handle angle; and
the handle assembly further comprises a handle body reset component (310) configured to move the handle body (302) from the second handle angle towards the first handle angle.

8. A vehicle, comprising:
a vehicle body (402); and
the handle assembly according to any one of claim 1, the base (102) being connected to the vehicle body (402).

9. The vehicle according to claim 8, further comprising:
an external body sheet metal (406) being connected to the vehicle body (402);
wherein the handle body (302) has a closed position and an open position, and is rotatable relative to the base (102) between the closed position and the open position; and
the external body sheet metal (406) and the handle assembly are configured such that: when the handle body (302) is in the closed position, an outer surface (111) of the cover plate (304) is flush with the external body sheet metal (406).

10. The vehicle according to claim 8, wherein:
the handle body (302) is rotatable about a first axis relative to the base (102), and the cover plate (304) is rotatable relative to the base (102) about a second axis (Y) different from the first axis (X); and
the first axis (X) and the second axis (Y) are provided substantially in a vertical direction.
